(19) United States
(12) Patent Application Publication
(10) Pub. No.: US 2002/0186902 A1
(43) Pub. Date: Dec. 12, 2002

(54) Ball bearing valve guide

(76) Inventor: Robert J. Leasure, Cherokee, NC (US)

Correspondence Address: Robert J. Leasure, P.O. Box 444, Cherokee, NC, 28719, US

(21) Appl. No.: 09/875,641

(22) Filed: Jun. 6, 2001

(51) Int. Cl. F16C 29/04

(52) U.S. Cl. 384/49

(57) ABSTRACT

Essentially instead of a shaft reciprocating within a tube at close tolerances it rides on the radius of ball bearings creating surface area reduction.

### BACKGROUND OF THE INVENTION

The invention relates to a valve guide for an internal combustion engine.

A valve guide assembly includes a machined valve guide including an outer cylindrical surface and an inner bore having an exemplary diameter of 0.343 inch. The valve-guide is pressed into a suitable bore in the cylinder head of an internal combustion engine.

A valve having a head and stem reciprocates within the bore, driven by a conventional cam machanism.

Within the valve guide are a plurality of semi-cyclindrical channels, opening into the bore of the guide. Three or more of these channels may be bored within the guide.

Retained in the semi-cylindrical channels are a plurality of ball bearings. An exemplary diameter of 0.0315 inch, which reciprocate in an exemplary bore diameter of 0.033 inch.

The bore is located within the guide, such as to permit the ball bearings, to protrude into the bore, such as to permit the valve stem to ball the only surface bearing area. This greatly reduces surface area and thereby friction within the valve guide.

The ball bearings are retained within their bore by means of an internal snap ring.

### BRIEF DESCRIPTION OF THE DRAWINGS

FIG. 1 is a side elevation view, partly in cross-section, of a valve guide embodying the invention; and

FIG. 2 is a cross-section taken on line 2-2 of FIG. 1, with some elements omitted.

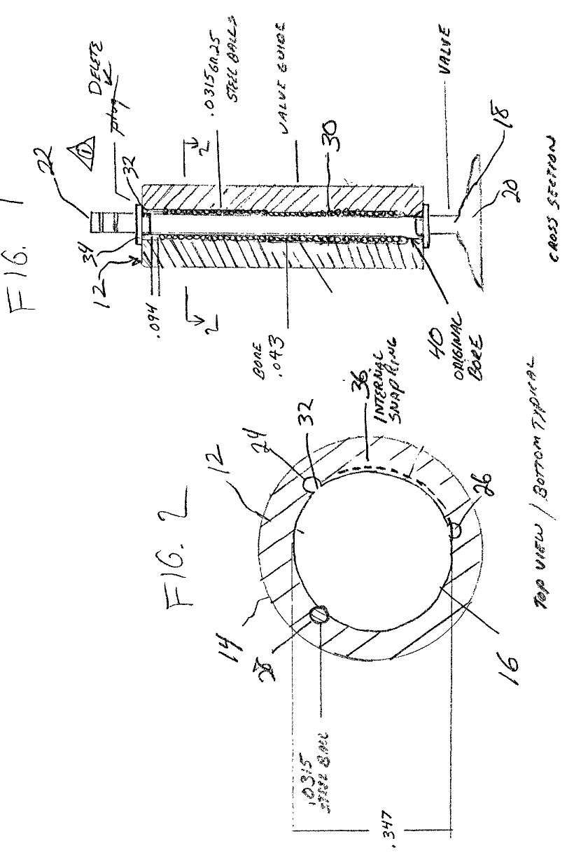

### DETAILED DESCRIPTION

With reference to the drawings, a valve guide assembly, generally designated 10, includes a machined valve guide 12 including an outer cylindrical surface 14 and an inner bore 16, having an exemplary diameter of 0.343 inch. The valve guide 12 is pressed into a suitable bore in the head of the internal combustion engine, as is well known.

A valve 18 having a head 20 and a stem 22 reciprocates within the bore 16, driven by conventional cam mechanism (not shown).

Within the valve guide 12 are a plurality of semi-cylindrical channels 24, 26, and 28, opening into the bore 16. In the illustrated embodiment there are three such semi-cylindrical channels 24, 26, and 28. However, a greater number, such as four, may be provided if desired.

Retained in the semi-cylindrical channels 24, 26 and 28 are a plurality of ball bearings 30. In the exemplary embodiement, the semi-cylindrical channels 24, 26, and 28 have a diameter of 0.033 inch, and retain ball bearings having an exemplary diameter of 0.0315 inch. The semi-cylindrical channels 24, 26, and 28 have openings, such as the representive opening 32, configured such that ball bearings 30 project into the bore 16 approximately 0.001 inch, so as to contact the valve stem 22, and prevent direct contact between the valve stem 22 and the bore 16.

The ball bearings 30 are retained within the semi-cylindrical channels 24, 26, and 28 by representive plugs 34 and 36, or by any suitable alternative, such as an internal snap ring cooperating with suitable machined structure on the valve guide 12.

At the bottom end of the guide there is an area of original bore 40, to aid in the heat transfer and sealing purposes.

### SUMMARY OF INVENTION

Ball bearings incorporated within the wall of a valve guide reduces surface area, therefore reducing friction.

What I claim as my invention is the ball bearing valve guide.

1. Which is a valve guide that has it's original bore enlarged so their is no contact between the valve stem and valve guide.

2. Steel ball bearings reciprocate within a bore of their own, within the wall of the valve guide, this bore is located in such a way that the ball bearings protrude into the bore of the valve guide, therefore the only area of contact is valve stem to the radius of the ball bearings, thus greatly reducing friction.

3. It is a relatively simple concept and design which I claim to be the sole inventor.
